(19) United States
(12) Patent Application Publication
(10) Pub. No.: US 2013/0132278 A1
(43) Pub. Date: May 23, 2013

(54) MULTI-SOURCE DEBIT CARD SYSTEM AND METHOD

(71) Applicant: Weiss Enterprises, Inc., Wabash, IN (US)

(72) Inventor: Jessica M. Weiss, Wabash, IN (US)

(73) Assignee: Weiss Enterprises, Inc., Wabash, IN (US)

(21) Appl. No.: 13/681,783

(22) Filed: Nov. 20, 2012

Related U.S. Application Data
(60) Provisional application No. 61/629,542, filed on Nov. 21, 2011.

(51) Int. Cl. G06Q 20/34

(52) U.S. Cl. CPC G06Q 20/349
USPC 705/44; 705/35

(57) ABSTRACT

The present invention involves a server based system and method which enables multiple source reloading of a single debit card.

### CROSS-REFERENCE TO RELATED APPLICATIONS

The present application claims priority under 35 U.S.C. §119(e) of U.S. Patent Provisional Application Ser. No. 61/629,542, titled RELOADABLE DEBIT CARD, filed November 21, 2011, the disclosures of which is incorporated by reference herein.

### BACKGROUND OF THE INVENTION

1. Field of the Invention

The invention relates to financial transaction software. More specifically, the field of the invention is that of financial transaction software for the debit card industry.

2. Description of the Related Art

Debit cards are a financial transaction card that allows a user to directly transfer money for a purchase to a vendor. Used much like a credit card, the debit card differs in that there is an immediate transfer of funds, wherein the credit card payment does not transfer funds until the charge card bill is paid.

The debit card is typically funded through a bank account. The owner of the bank account may reload a debit card by depositing more funds into the connected bank account. Gift cards have been developed that function similar to a debit card, but which are funded by the transfer of funds from the gift card purchaser to the financial institution sponsoring the gift card. In this way, a person may provide a cash-like gift card to another person. Some gift cards are reloadable, that is they allow further funds to be associated with the card.

### SUMMARY OF THE INVENTION

The present invention is a multiple-source debit card system and method which allows multiple individuals to provide funds to a single debit card without the multiple individuals needing to know any bank account information. In one embodiment, multiple sources may reload the account associated with the debit card. In another embodiment, a closed loop debit card may be funded from multiple sources.

In several embodiments, identity modules are used to identify the sources of funds. Such identity modules may come from several sources, including an independent web site, a social network and its credentialing of its members, a financial institution, and/or an independent identity service. In these several embodiments, the identity module provides verification of the source of the funds, and may provide the funds as well. By having an identity modules to determine the source of the funds, the financial institutions involved may satisfy accounting and regulatory compliance as a matter of routine and provide the underlying framework for the open or closed loop multiple-sourced debit card.

In one embodiment, the invention involves a reloadable debit card that may be loaded by anyone with a major credit card. The individual reloading the debit card my use the credit card through conventional checkout procedures, including telephone ordering, kiosk entry, and web site interaction. The resulting debit card may be given to the person or organization in need of funds at occasions such as weddings, graduations, funerals, hospitalizations, children going off to college or into military service.

In another embodiment, the invention involves a kit including a debit card and at least one information card containing account activating and/or funding information. The activating information may include special telephone numbers, internet addresses, and activation codes for enabling and funding the debit card. An individual may obtain the kit, use one of the methods of communication to activate the debit card, and provide the information cards to other individuals who may desire to help the recipient of the debit card. For example, at a hospital, an individual may obtain such a kit, activate the debit card, provide initial funding from the hospital and provide the debit card to someone at the hospital, such as a loved one staying with a injured patient. Further, the remaining information cards may be distributed to other people who might have an inclination to help out through further funding of the debit card.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagram of the operation of one embodiment of the present invention relating to multiple sources funding a debit card through a call center.

FIG. 2 is a schematic diagram of the operation of one embodiment of the present invention relating to multiple sources funding a debit card through a kiosk.

FIG. 3 is a schematic diagram of the operation of one embodiment of the present invention relating to multiple sources funding a debit card through a web site.

FIG. 4 (presented on two sheets, labeled 4 & 4B) is a schematic work flow diagram of the funding of a debit card according to embodiments of the present invention.

FIG. 5 is a graphic representation of a situation where embodiments of a multi-source reloadable debit card of the present invention could be used.

FIG. 6 is a workflow diagram representation of the use of an embodiment of the present invention through a social network.

FIG. 7 is a illustration of one embodiment of the invention in the form of a kit.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

Embodiments of the present invention allow multiple parties to fund a debit card, for example to assist an individual in an emergency time of need. WeCare Card service center represents the organization that enables the multiple party debit card. The WeCare Card service center may be embodied by several different forms, each of which provide a system in which a single individual, hereinafter termed the initiator, may create a fund source for a debit card usable by another individual, hereinafter termed the donee, and enable other third parties, hereinafter contributors, to provide funds to the donee. The WeCare Card service center receives the various identity information from the initiator and the donee, and then transacts with the with a financial institution to create, fund, and manage the WeCare Card debit card that is issued to the donee. In addition, the WeCare Card service center also records the identity and amounts of the contributors and the donee for the any financial reporting requirements. The initiator may start the process by contacting the WeCare Card service center, either directly, or through contact information contained in a kit. The kit has a WeCare Card debit card that may be quickly funded using the initiation instructions, given to the donee, and funded by the initiator and/or other contributors that receive contribution instructions.

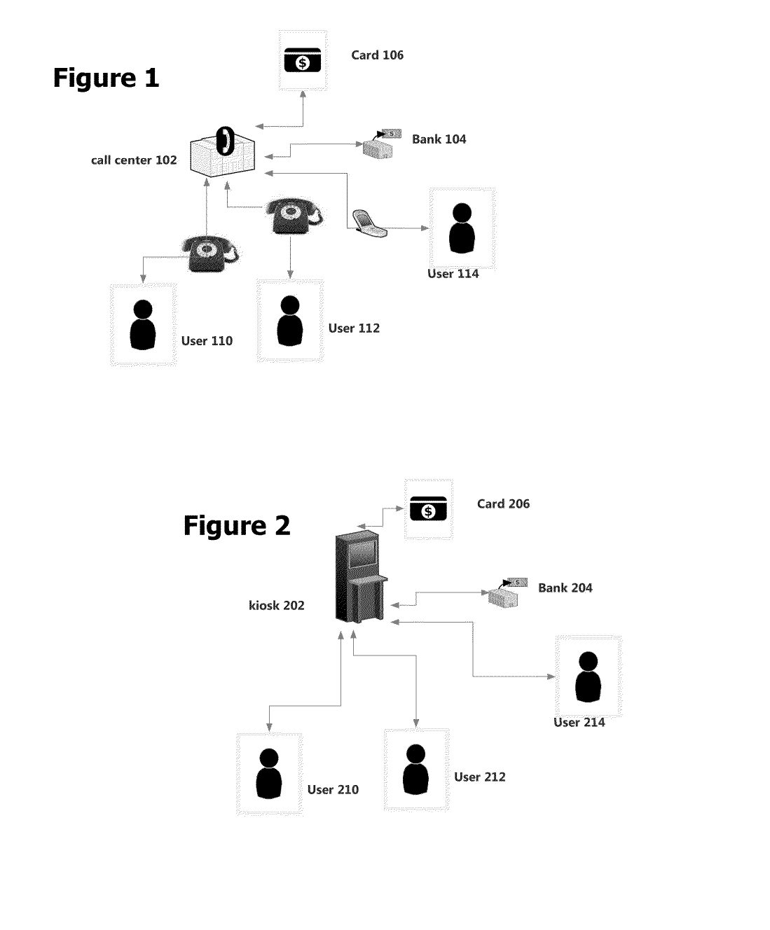

In one embodiment, shown in FIG. 1, WeCare Card call center 100 is connected to conventional telephony networks, and may be contacted by users 110, 112, and 114 through telephony exchanges, e.g., land line telephones or mobile phones. Call center 102 is also in communication with financial institutions, such as bank 104 and card 106, so that when one of users 110, 112, or 114 opts to become an initiator, call center 102 may obtain the information about the initiator, the donee, and fund the debit card. Subsequently, other ones of users 110, 112, or 114 may contact call center 102 and opt to become a contributor. In one embodiment, the donee is identified by name and the contributors specify the individual to be the donee over the telephone. In other embodiments, the initiator starts the process for obtaining a kit having a WeCare Card debit card, information about activating the debit card for a donor, and several additional information cards containing identifying information about the debit card and the funding mechanism. Such information cards includes, for example, the telephone number of call center 100, and a unique code for the debit card. Contributors would receive this information, telephone call center 100 and express the desire to fund the debit card identified by the unique code. Call center 100 may obtain funding information from each contributor, e.g. a credit card number and credentials acceptable by card 106, or a bank account number and routing number for bank 104. Additionally, call center 100 may confirm the desire to contribute to the donee by identifying the donee to the contributor. Assuming that the donee is acceptable to the contributor, and the contributor's funding information is valid, the contributor may thus further fund the debit card for the donee.

When the donee receives the WeCare Card debit card, the donee may also be provided with activation materials. Delivery may be by hand, for example when the initiator obtains a kit and then gives the WeCare Card debit card to the donee on a visit and includes activation materials. Alternatively, if the initiator started the process by telephoning call center 100 and identified the donee, call center 100 would then send the WeCare Card debit card to the donee, for example by post, express delivery, or special delivery. As a further alternative, call center 100 may provide the donee with information by which the donee could go to a bank or kiosk and have the WeCare Card debit card produced. Such activation materials may include a magnetically or visually encoded strip, bar, or section that could be scanned, read, or otherwise detected by a machine. Activation materials may alternatively include a code or series of codes that would be used with a particular interface to identify donee and confirm the receipt of the WeCare Card debit card.

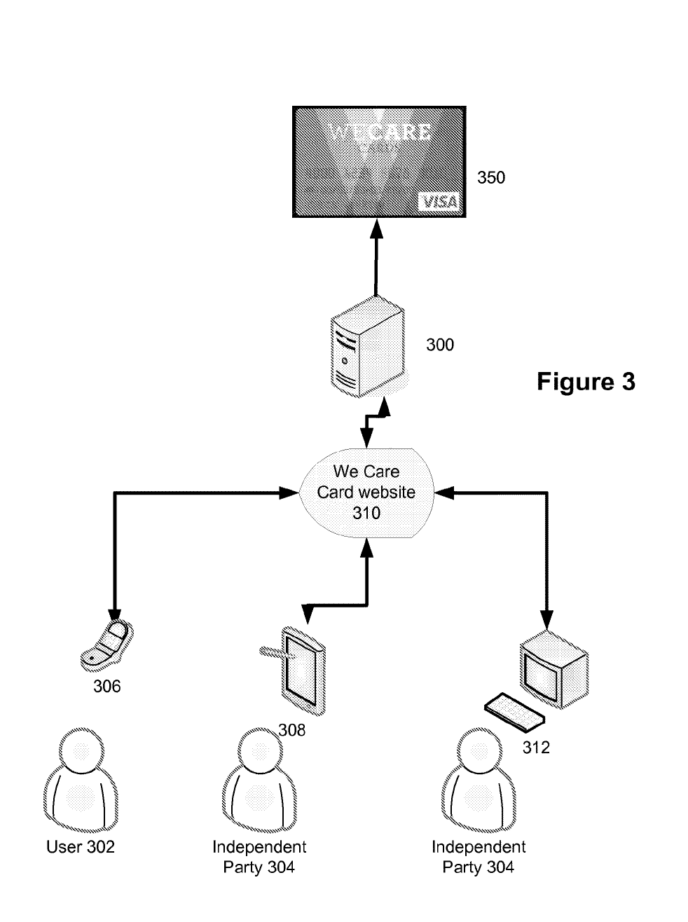

Similarly, FIG. 2 shows an embodiment of the system of the present invention being deployed using kiosks. Kiosk 200 is in communication with bank 204 and card 206 to allow users 210, 212, and 214 to participation in the funding of a WeCardCard debit card (not shown in FIG. 2). In one embodiment, the donee is identified by name and the contributors specify the individual to be the donee by typing into kiosk 200. In other embodiments, the initiator starts the process for obtaining a kit having the debit card, information about activating the debit card for a donor, and several additional information cards containing identifying information about the debit card and the funding mechanism. Such information cards includes, for example, the location(s) of kiosk 202, and a unique code for the debit card. Contributors receive this information, interact with kiosk 202, for example by typing into a keyboard/display combination or talking into a microphone and/or responding to touch screen information. Such contributors interact with kiosk 202 to express the desire to fund the WeCare Card debit card identified by the unique code. Kiosk 202 may obtain funding information from each contributor, e.g. a credit card number and credentials acceptable by card 206, or a bank account number and routing number for bank 204. Additionally, kiosk 202 may confirm the desire to contribute to the donee by identifying the donee to the contributor. Assuming that the donee is acceptable to the contributor, and the contributor's funding information is valid, the contributor may thus further fund the debit card for the donee.

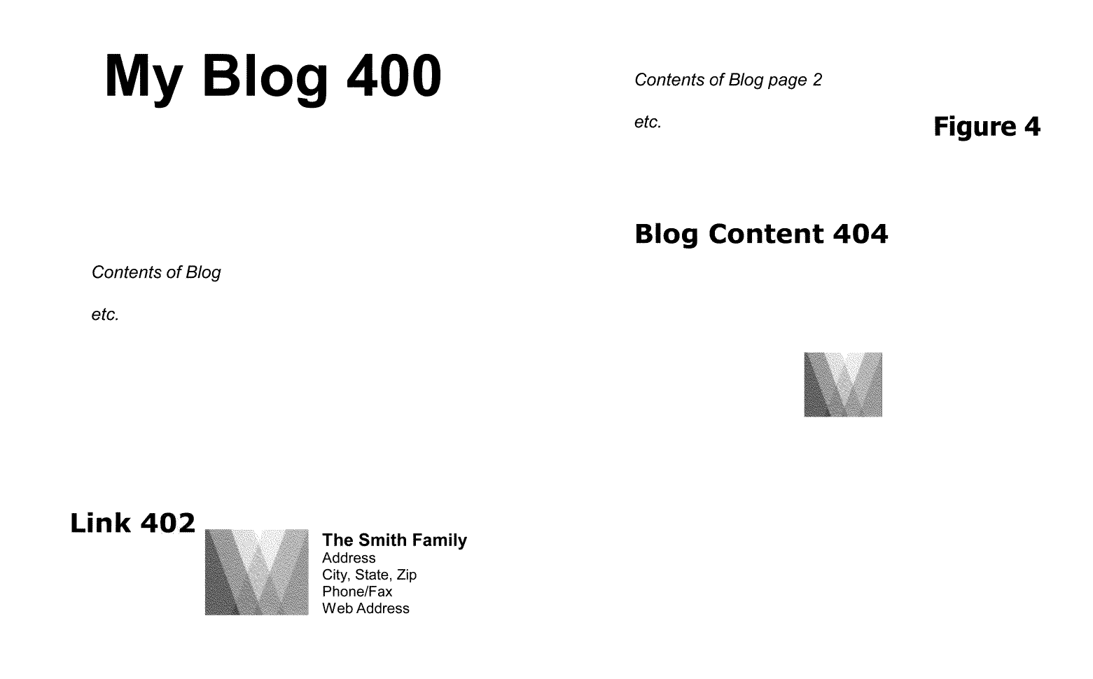

In an exemplary embodiment of the invention shown in FIG. 3, server 300 facilitates both the creation of debit card 350 by initiating user 302, and the reloading of debit card 350 by independent parties 304. One method of enabling this procedure is for initiating user 302 to specify the recipient of debit card 350, then for initiating user 302 providing identifying information to one of independent parties 304. For example, a link sent via e-mail or a button on a social network post may initiate a message from independent party 304 to server 300 to start a transfer of funds from independent party 304 to debit card 350.

A debit card, in one embodiment of the invention, may be created by user 302 visiting We Care Card website 310 and initiating the creation of a WeCare Card debit card (not shown). For example, user 302 may sponsor a debit card to provide funds for a friend in a difficult situation (e.g., stranded in a remote location because a family member became ill while on a trip). User 302 may fund the card by a conventional transaction, in one embodiment by an e-commerce exchange through website 310, in an alternative embodiment by submitting cash into a kiosk (not shown) that confirms the receipt of cash to web site 310. We Care Card website 310 then initiates the creation of the physical debit card and arranges for the physical debit card to be delivered (e.g., by overnight delivery) to the friend/recipient. In another embodiment, We Care Card website 310 sends a message (e.g. by mobile phone text message or electronic mail) to the recipient with identifying information so that the recipient may obtain the debit card from another kiosk, automatic teller machine (ATM) terminal, internet terminal, bank teller, or banking facility. In these various embodiments, the recipient obtains the debit card and is able to use the funds associated with the card without having to attend to setting up an account or otherwise dealing with the financial institution that provides the debit card account.

In addition to providing basic gift card functionality, We Care Card website 310 also facilitates independent parties 304 providing funds to the debit card for the recipient, either initially for a closed loop debit card, or after the delivery of the card for a reloadable debit card. In one embodiment, We Care Card website 310 provides a listing of available debit cards for initial funding or additional reloading. Such a listing may be alphabetically arranged, geographically arranged, or searchable so that individuals may visit We Care Card website 310, view the available debit cards and their associated recipients, and initiate an e-commerce transaction to provide additional funding to the debit card. In another embodiment, We Care Card website 310 provides a description of the debit card recipient and an associated link to a funding section of website 310 so that user 302, or any of the independent parties 304, may post the description and link to a social network to assist raising funds for the recipient. In another embodiment, We Care Card website 310 provides user 302 or independent parties 304 to send electronic mail messages containing the description and/or the link. In further embodiments, the functions described in this paragraph are conducted through a mobile device app, e.g. using cell phone 306 or tablet 308, rather than through conventional computer 312. In still further embodiment, the functions described in this paragraph are conducted through a kiosk which may have a cash deposit or ATM terminal for receiving funding. In still further embodiments, some aspects of the process described above occur in a system having a call center such as described in relation to FIG. 1, others over a kiosk such as described in relation to FIG. 2, and still others over a web site such as described in relation to FIG. 3.

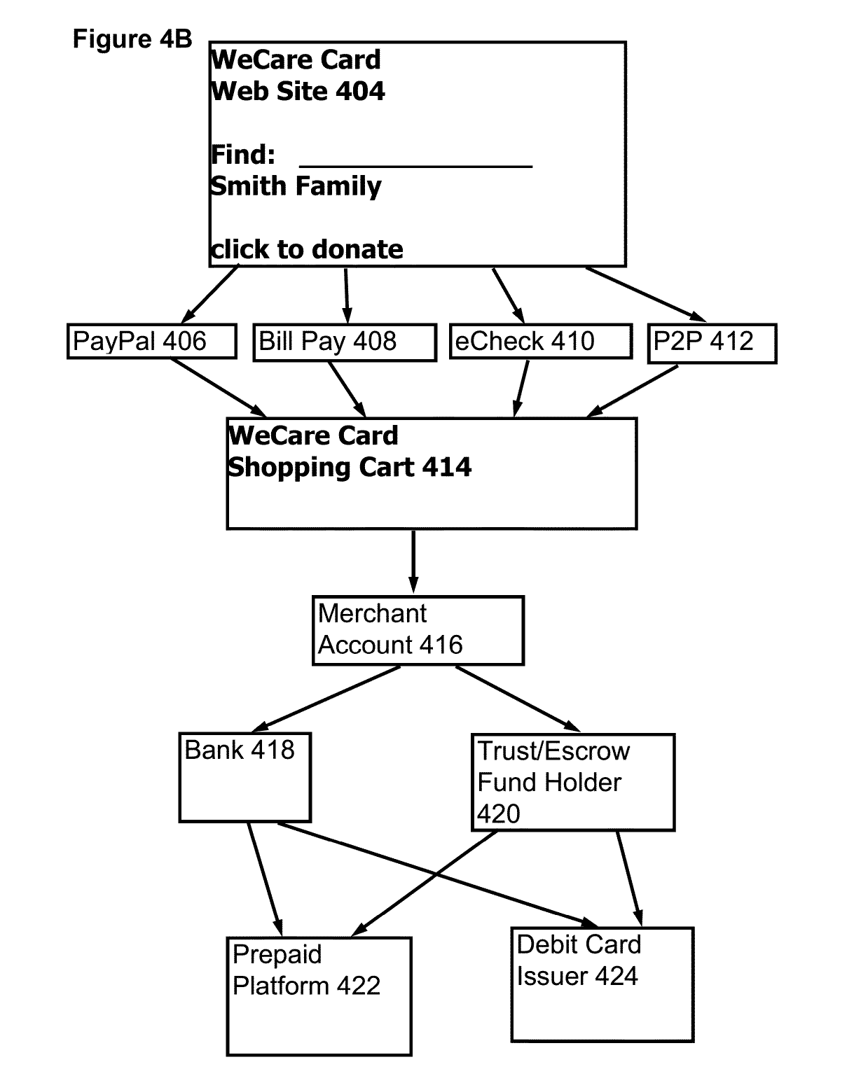

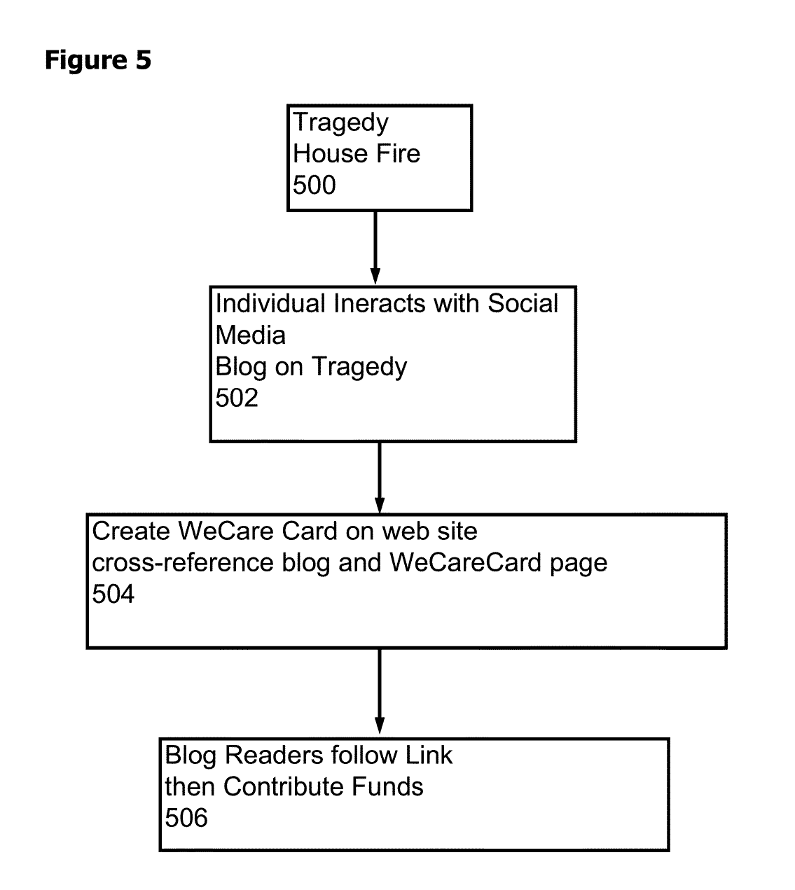

FIGS. 4 and 4B illustrates a workflow of the operation of an embodiment of the present invention. The starting point may be a blogger writing in blog site 400 about a situation (e.g., see discussion of FIG. 5 below), in this example about the Smith family, wherein someone has initiated a “We Care Card” for the Smith Family. Blog site 400, for example a social network, may include deep link 402 to the corresponding page or pages for the Smith family at the We Card Card web site 404. The individual viewing Blog site 400 may click to donate to the Smith family WeCare Card by clicking on a donate button of that particular page of WeCare Card website 404, and invoke one of e-commerce processes 406, 408, 410, 412. In the illustrated work flow, payment processes such as PayPal [406], Bill Pay [408], eCheck [410], P2P [412], or other suitable e-commerce payment system to transfer funds from personal bank account or other funding source to WeCare Card website shopping cart 414, from which funds are transferred to merchant account 416 and then to bank 418 or other trust/escrow fund holder 420. WeCare Card shopping cart 414 sends the funds with an identification of the target recipient debit card, which may be reloaded by prepaid platform 422, or if the debit card has not yet been issued then the funds from shopping cart 414 may fund the issuance of the debit card by debit cart issuer 424.

FIG. 5 illustrates a situation suitable for such a workflow, wherein a family may need assistance because of a house fire [500]. A family member or another individual may start the We Care Card funding process by interacting with social media to notify multiple individuals of the house fire and the family in need of emergency funds, for example by writing a blog entry about the house fire and the individuals in distress [502]. Concurrently, someone starts a We Care Card for the family at the We Care Card website [504] so that the social media blog can reference the deep link to the family's We Care Card page. Alternatively, the blog writer may independently write about the family's plight, and a reader may start a We Care Card for the family and post a donation link as a comment to the blog entry. In either event, multiple readers of the blog entry may follow the link and contribute funds to the family's debit card [506].

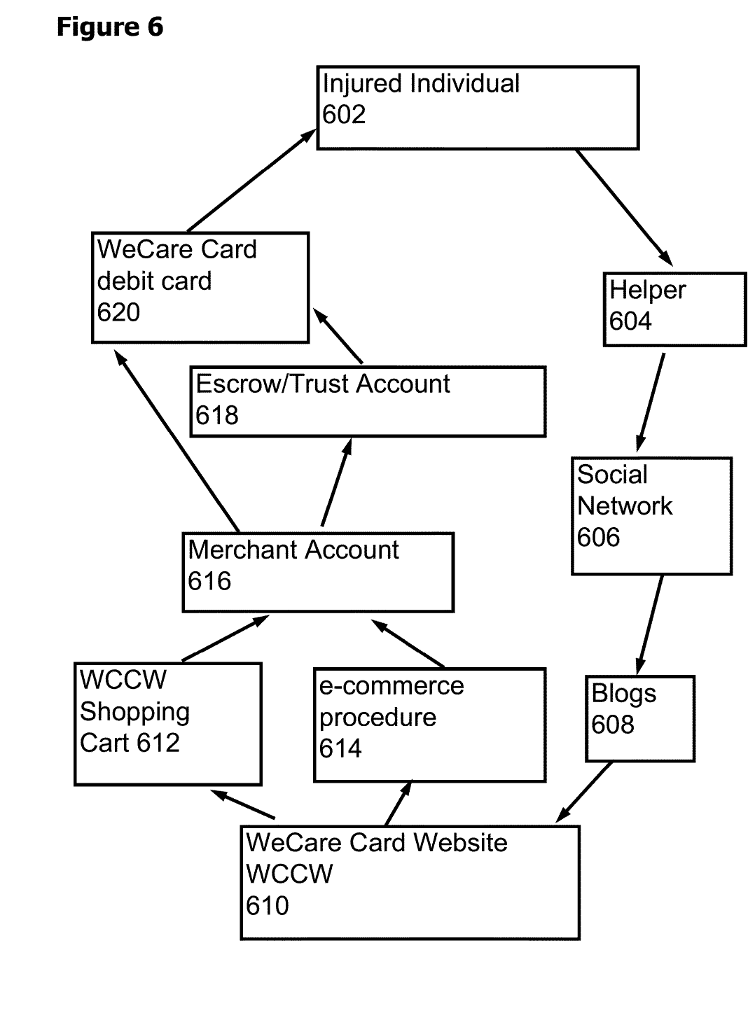

FIG. 6 illustrates how the social situation of FIG. 5 and the network schematic of FIG. 4 may interact in one embodiment of the invention. Injured individual 602, e.g. an individual with a broken leg, may be noticed by another individual, helper 604, who offers help. Within social network 606, helper 604 may publicize the plight of injured individual 602 regarding the broken leg. Helper 604, or others, may then start publishing blogs 608 of the plight of the person with the broken leg and then associating those discussions with links to We Care Card website (WCCW) 610. Such links may either a general link to WCCW 610 (requiring a follower of the link to look for injured individual 602) or an embedded link that takes the follower directly to the specific page or pages on WCCW 610 relating to injured individual 602. Anyone visiting the injured person's WCCW page(s) may invoke WCCW shopping cart 612, or other e-commerce procedure 614 to get funds to merchant account 616. Once in merchant account 616, the funds may optionally stay in escrow/trust account 618 (in anticipation of the issuance of a debit card) or directly reload existing WeCare Card debit card 620 that is associated with injured person 602. Through this process, multiple persons may be notified of the distress of injured person 602 and take steps to provide needed funds to that person through e-commerce processes to WeCare Card debit card 620 without having to set up any special fund transfers.

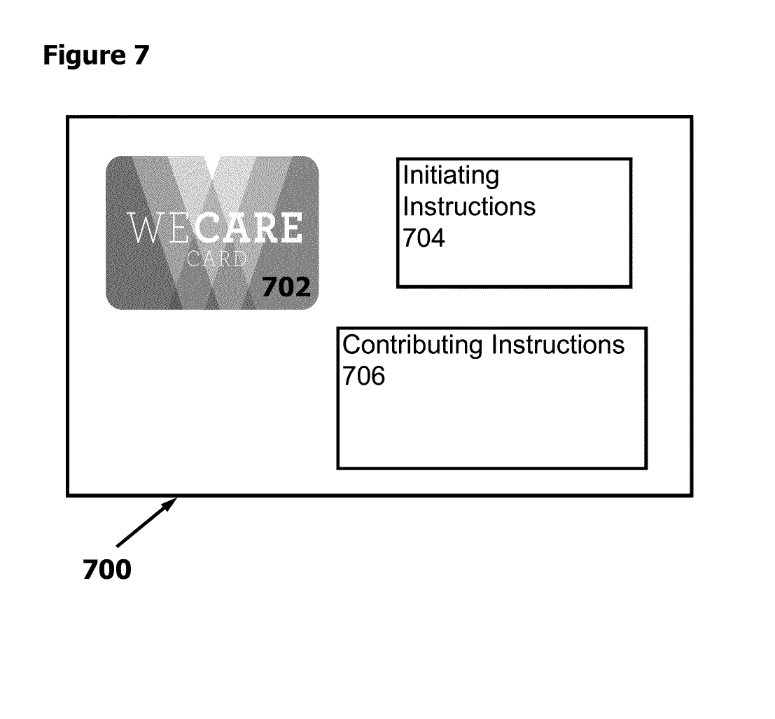

FIG. 7 shows one embodiment of the invention involving kit 700. For example, a hospital may provide kit 700 to individuals visiting the hospital. Kit 700 includes WeCare Card debit card 702, Initiating instructions 704, and Contributing instructions 706. Instructions 704 and 706 may be in the form of printed materials, printed coded materials for reading by an electronic device (e.g., bar codes or QR codes), or an electronic medium having instructions in computer-readable formats. An individual visiting a patient may observe the patient or one of the patient's loved ones in some financial difficulty. The individual may obtain kit 700, use Initiating instructions to provide initial funding for WeCare Card debit card 702, and provide card 702 to the patient or loved one to use. Further, the individual may publicize Contributing instructions 706 by leaving such instructions with the patient or loved one, sending such instructions to other individuals whom might have an interest in becoming a contributor, and/or posting contributing instructions to a blog or other outlet.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A service center for providing an interface for a multi-source debit card, said server comprising:
a receiving module capable of receiving a communication instructing the creation of a debit card;
an identity module capable of receiving identity information from a plurality of individuals; and
a transaction processing module, said transaction processing module being in communication with a financial institution and linked to the identity module to be capable of providing identity information to the financial institution, the identity information including the identity of the owner of the debit card.

2. The service center of claim 1 wherein said transaction processing module also obtains and send to the financial institution the identity of a plurality of individuals providing funds to the debit card.

3. The service center of claim 1 wherein the receiving module includes a call center.

4. The service center of claim 1 wherein the receiving module includes a web site.

5. The service center of claim 4 wherein said web site includes a blogging area.

6. The service center of claim 1 wherein the receiving module includes a kiosk.

7. The service center of claim 1 wherein the receiving module includes an address obtaining module for obtaining the mailing address of the owner of the debit card, and mails the debit card to the owner.

8. A method of providing a multi-source debit card, said method comprising the steps of:
providing a receiving module accessible to individuals and allowing at least one of the individuals to identify a target debit card owner;
accepting a first payment from a first source through the receiving module and crediting the first payment to an account associated with the target debit card; and
accepting a second payment from a second source through the receiving module for the target debit card and crediting the second payment to the account associated with the target debit card.

9. The method of claim 8 wherein the receiving module includes a call center.

10. The method of claim 9 wherein the receiving module includes a kiosk.

11. The method of claim 9 wherein the receiving module includes a web site.

12. The method of claim 11 wherein said web site includes a blogging area.

13. The method of claim 9 wherein the receiving module includes a kiosk.

14. The method of claim 9 wherein the receiving module includes an address obtaining module for obtaining the mailing address of the owner of the debit card, and further including the step of mailing the debit card to the owner.

15. A kit for enabling multiple parties to fund a debit card, said kit comprising:
a debit card;
initiation instructions for enabling an individual to set up a debit card for another individual; and
contribution instruction for enabling a third individual to provide funds for the debit card.

16. The kit of claim 15 wherein said contribution instructions includes a plurality of printed materials identifying how another individual contributes to the funding of the debit card.

17. The kit of claim 15 wherein said initiation instructions includes contact information for a service center capable of creating a debit card for an individual wherein said debit card may be funded by another individual.

18. The kit of claim 15 wherein said debit card is reloadable.

19. The kit of claim 15 wherein said contribution instructions are in electronic form.

20. The kit of claim 19 wherein said contribution instructions are capable of being posted to a social network.
